(19) United States
(12) Patent Application Publication
(10) Pub. No.: US 2026/0187309 A1
(43) Pub. Date: Jul. 2, 2026

(54) METHOD FOR ASSESSING WIND LOADS ON TREES BASED ON POINT CLOUD MODELS

(71) Applicant: TONGJI UNIVERSITY, Shanghai (CN)

(72) Inventors: Yi Rui, Shanghai (CN); Yu Xin Zhang, Shanghai (CN); Xiao Jun LI, Shanghai (CN); Hehua ZHU, Shanghai (CN); Pei Nan LI, Shanghai (CN); Mei YIN, Shanghai (CN); Pei WANG, Shanghai (CN); Ting Chen FANG, Shanghai (CN); Jian Rong CHEN, Shanghai (CN); Tong WANG, Shanghai (CN)

(73) Assignee: TONGJI UNIVERSITY, Shanghai (CN)

(21) Appl. No.: 19/433,051

(22) Filed: Dec. 25, 2025

(30) Foreign Application Priority Data
Dec. 27, 2024 (CN) 202411945984.0

(51) Int. Cl. G06F 30/23; G06T 7/55; G06T 7/73; G06T 7/77; G06V 10/30; G06V 10/46; G06V 20/10; G06V 20/17; G06V 20/64; G06V 20/70

(52) U.S. Cl. CPC G06F 30/23; G06T 7/55; G06T 7/75; G06T 7/77; G06V 10/30; G06V 10/46; G06V 20/17; G06V 20/188; G06V 20/647; G06V 20/70; G06T 2207/10028

(57) ABSTRACT

A method for assessing wind loads on trees based on point cloud models. This is achieved by performing semantic segmentation on images captured by unmanned aerial vehicles (UAVs), extracting images of the tree crowns for three-dimensional reconstruction, generating point cloud models, extracting point cloud data for both the crowns and trunks, and ultimately producing three-dimensional point cloud models for the target trees. Calculate the wind load impact area of tree crowns using the Alpha Shape algorithm. Combining wind speed, wind direction and tree geometric characteristics, simulate wind load distribution under varying wind direction and speed conditions using ANSYS Fluent software, and compute wind load results under applied wind loads. Finally, utilizing finite element analysis methods in conjunction with wind load data, structural stress analysis of trees is conducted to evaluate their fatigue lifespan and failure risk under wind loads.

### CROSS-REFERENCE TO RELATED APPLICATION

This application claims the priority benefit of Chinese patent application No. 2 02411945984.0, filed on Dec. 27, 2024. The entirety of the above-mentioned patent application is hereby incorporated by reference herein and made a part of this specification.

### BACKGROUND

### Technical Field

The present invention relates to the field of tree assessment technology, specifically concerning a method for assessing wind loads on trees based on point cloud models.

### Description of Related Art

With the intensification of climate change and the increasing frequency of extreme weather events, the threat posed by wind disasters to urban areas is growing. The behavior of trees under wind loads—including bending, swaying, and even breaking—has become a critical focus in wind disaster prevention research. Particularly during high-wind conditions, a tree's wind resistance directly impacts environmental safety, public infrastructure, and the protection of human life and property. Currently, tree wind load assessment primarily relies on manual observation and traditional wind models, yet these methods often suffer from insufficient accuracy, poor real-time applicability, and limited scope.

Conventional tree wind load evaluation methods predominantly employ simplified wind tunnel experiments or empirical estimation techniques, failing to accurately reflect trees' dynamic responses in complex environments. Advancements in technology have introduced new possibilities for tree wind load assessment through drone-captured imagery and three-dimensional reconstruction techniques. Nevertheless, existing research remains nascent regarding the generation of accurate tree point cloud models from imagery and their application for automated wind load assessment and structural analysis. Furthermore, the comprehensive analysis of multi-directional wind loads remains an unsolved challenge.

### SUMMARY

The objective of the present invention is to overcome the shortcomings of the prior art by providing a tree wind load assessment method based on point cloud models.

This objective may be achieved through the following technical solution:

This invention addresses shortcomings in existing techniques by proposing a tree wind load assessment method based on point cloud modelling. Utilizing unmanned aerial vehicle (UAV) image acquisition, semantic segmentation, and point cloud reconstruction technologies, combined with wind load calculations and tree structural stress analysis, this method enables more precise evaluation of trees' wind resistance capabilities. It provides a scientific basis for wind disaster early warning and emergency response.

The present invention provides a point cloud model-based tree wind load assessment method, comprising the following steps:
Employ unmanned aerial vehicles to capture multi-angle imagery of target trees, thereby acquiring visual representations of the subject trees;
Apply image semantic segmentation algorithms to annotate the imagery, generating labels for each pixel within the images. These labels encompass tree crowns, tree trunks, and background elements;
Construct a preliminary three-dimensional point cloud model based on the annotated imagery. Each point cloud data point within this preliminary model incorporates corresponding label information.

Generate a three-dimensional point cloud model of the target tree based on the preliminary three-dimensional point cloud model and its label information;

Calculate the wind load impact area of the tree crown based on the aforementioned three-dimensional point cloud model of the target tree;

Simulate multi-directional wind loads based on the wind load impact area of the canopy, wind speed, and the target tree's geometric characteristics to obtain wind load simulation results, wherein the target tree's geometric characteristics are derived from the target tree's 3D point cloud model;

Conduct structural stress analysis on the tree in conjunction with the wind load simulation results to predict the risk of tree failure under wind forces.

Furthermore, the process of annotating images using image semantic segmentation algorithms to generate labels for each pixel within the image comprises the following steps:

Perform preprocessing operations on captured images, including denoising and color correction;

Input the preprocessed images into a pre-trained convolutional neural network model for semantic segmentation, outputting semantic segmentation maps for each image. Each pixel within the semantic segmentation map is assigned a label. The convolutional neural network model includes the Mask R-CNN model.

Furthermore, the process of constructing a preliminary three-dimensional point cloud model based on annotated images comprises the following steps:

Performing multi-view three-dimensional reconstruction of captured images using COLMAP three-dimensional reconstruction software to generate a non-semantic three-dimensional point cloud model;

Compute the three-dimensional coordinates of each pixel within the semantic segmentation map of each image in the non-semantic 3D point cloud model. Determine the corresponding point cloud data for each pixel based on its three-dimensional coordinates. Pass the labels of each pixel to the corresponding point cloud data to generate a preliminary 3D point cloud model.

Furthermore, the process of performing multi-view three-dimensional reconstruction on captured images using COLMAP three-dimensional reconstruction software to generate a non-semantic three-dimensional point cloud model comprises the following steps:

The SIFT algorithm is employed to extract feature points and their descriptors from each image. A nearest neighbor matching algorithm is then applied to match feature points across multiple images based on their respective descriptors. The RANSAC algorithm is utilized to eliminate erroneously matched feature points.

Based on the matched feature points, COLMAP is employed to construct a non-semantic 3D point cloud model through an incremental reconstruction method.

Furthermore, the generation of a target tree three-dimensional point cloud model based on the preliminary three-dimensional point cloud model and its label information comprises the following steps:
By utilizing the semantic segmentation maps of each image and the geometric characteristics of point cloud data within the preliminary 3D point cloud model, non-tree debris is removed through geometric conditions based on color, position, and normal vectors;
Point cloud data labelled as tree crowns and trunks is extracted from the preliminary 3D point cloud model;
Simplify the extracted point cloud data using a voxel grid algorithm, spatially partitioning the point cloud into a grid to reduce redundant points;
Apply the SOR filtering algorithm to remove noise from the point cloud data, generating a three-dimensional point cloud model of the target trees.

Furthermore, the calculation of the wind load impact area on the tree canopy based on the three-dimensional point cloud model of the target tree comprises the following steps:
Extract point cloud data labelled as tree crowns from the target tree's three-dimensional point cloud model to generate a three-dimensional point cloud model of the tree crown;
Project the canopy point cloud data from the three-dimensional canopy point cloud model along a predetermined direction, converting the three-dimensional canopy point cloud model into two-dimensional planar data;
Convert the three-dimensional coordinates within the three-dimensional canopy point cloud model into corresponding two-dimensional coordinates according to the predetermined direction, thereby obtaining a two-dimensional point set for the canopy.

Employing the Alpha Shape algorithm to compute the boundary envelope of the two-dimensional point set representing the tree crown yields the wind load impact area of the crown.

Furthermore, the preset direction undergoes dynamic adjustment based on variations in wind speed and direction.

Moreover, the wind load impact area of the tree crown is calculated using the following formula:

$$A = {\sum }_{i = 1}^{n} \frac{1}{2} \vert {x}_{i} {y}_{i + 1} - {x}_{i + 1} {y}_{i} \vert$$

Where A denotes the wind load-affected area of the tree crown, (xᵢ, yᵢ) represents the two-dimensional coordinates of the i-th point cloud data within the tree crown's two-dimensional point set, n signifies the total number of point cloud data points in the tree crown's two-dimensional point set, and (xₙ₊₁, yₙ₊₁) is regarded as forming a closed path with (x₁, y₁).

Furthermore, based on the wind load impact area of the canopy, wind speed, and the geometric characteristics of the target trees, multi-directional wind loads are simulated to obtain wind load simulation results, comprising the following steps:

Calculate the wind resistance coefficients at the tree crown and trunk based on the target tree's geometric characteristics. Generate a three-dimensional CAD model from the tree crown's point cloud data and import it into Fluent. Input the wind resistance coefficients at the crown and trunk into ANSYS Fluent software. Use Fluent to simulate wind velocity and pressure distributions generated by winds from multiple directions. Analyses the resulting flow field simulation outcomes to obtain wind load simulation results, calculated using the formula:

$$F = \frac{1}{2} \cdot {C}_{d} \cdot A \cdot ρ \cdot {v}^{2}$$

Where F denotes wind load, C_{d} represents the drag coefficient, A signifies the wind load-affected area of the canopy, ρ denotes air density, and v indicates wind velocity.

Furthermore, incorporating wind load simulation results, a structural stress analysis of trees is conducted to predict the risk of tree failure under wind loads, comprising the following steps:
Based on the three-dimensional point cloud model of the target tree, a finite element model of the tree is constructed. This finite element model incorporates the tree's geometric shape, material properties, mechanical characteristics, and boundary conditions.

The results of the wind load simulation are input into the finite element model, acting as external loads applied to each node or element within the finite element model. The structural stresses within the tree under wind load are calculated using the following formula:

$$σ = \frac{F}{{A}_{c r o s s}}$$

Where σ denotes stress, F denotes wind load, and A_{cross} denotes the cross-sectional area of the wind load application zone;

Based on the calculated structural stresses, combined with the fatigue strength and fatigue index of the target tree material, the fatigue life of the target tree under long-term wind loading is predicted using the following formula:

$${N}_{f} = {( \frac{Δσ}{{σ}_{f}} )}^{β}$$

Where N_{f} denotes fatigue life, Δσ denotes stress amplitude, obtained from the calculated structural stress, σ_{f} denotes the fatigue strength of the target tree material, and β denotes the fatigue index of the target tree material;

Assess the risk of failure of target trees under wind loads based on their predicted fatigue life under long-term wind loading.

Compared with the prior art, the present invention offers the following advantages:
(1) This invention comprehensively addresses the shortcomings in existing techniques for assessing wind loads on trees and analyzing fatigue damage. Traditional approaches often rely on static wind speed data and simplified mechanical models, making it difficult to accurately simulate trees' dynamic responses under complex wind conditions. Consequently, they fail to comprehensively evaluate trees' stress states and associated potential risks. By employing advanced CFD simulation techniques and tree geometric modelling methods, the present invention precisely simulates trees' dynamic responses under varying wind speeds and directions. Through stress analysis and fatigue calculations, it enables real-time assessment of trees' structural stability. Compared to existing techniques, this invention overcomes the shortcomings of traditional methods that neglect dynamic tree responses and complex wind load effects, delivering more precise and comprehensive wind load assessments. Integrated with urban emergency management systems and disaster prevention and mitigation systems, this system enables predictive analysis of tree damage during severe wind events. It provides scientific basis for wind disaster warnings and emergency response, thereby reducing losses to public facilities, human life, and property during wind-related disasters.
(2) This invention employs unmanned aerial vehicles to capture imagery and utilizes image semantic segmentation algorithms to construct high-precision three-dimensional point cloud models of target trees. This approach circumvents the high costs and low efficiency associated with traditional manual surveying methods, whilst enabling the precise extraction of structural information (such as crowns and trunks). Consequently, it provides more accurate geometric data for subsequent wind load analysis.
(3) This invention employs the COLMAP three-dimensional reconstruction software to construct point cloud models. By integrating results from image semantic segmentation and utilizing automated algorithms to extract the three-dimensional geometric information of trees, it significantly enhances the efficiency and precision of point cloud model construction. This method effectively removes background clutter and noise, ensuring the accuracy and operational feasibility of the tree models.
(4)) This invention employs the Alpha Shape algorithm to calculate the wind load exposure area of tree crowns. It dynamically adjusts the wind load exposure area of tree models under varying wind direction conditions and accurately determines the actual exposed surface area of tree crowns. This provides reliable data support for subsequent wind load simulation and assessment.
(5) This invention employs Fluent software to simulate multi-directional wind loads. By inputting three-dimensional CAD models of trees alongside wind resistance coefficients, it simulates wind velocity and pressure distributions across multiple orientations, thereby yielding precise wind load simulation results. This technical approach enables comprehensive analysis of wind loads under varying wind directions and velocities, providing a more scientific basis for structural assessment of trees subjected to wind forces.
(6) This invention employs finite element modelling to conduct structural stress analysis of trees. By calculating the structural stresses within trees under wind loads and integrating the fatigue strength and fatigue index of tree materials, it accurately predicts the fatigue lifespan of trees subjected to prolonged wind exposure. This technology provides a scientific basis for tree health assessment and wind damage risk prediction, facilitating the early warning and management of wind-related hazards to trees.

### BRIEF DESCRIPTION OF THE DRAWINGS

FIG. 1 illustrates the overall method flowchart of the present invention;

FIG. 2 depicts the data acquisition and semantic segmentation flowchart of the present invention;

FIG. 3 shows the point cloud model generation flowchart of the present invention;

FIG. 4 presents the wind load simulation calculation flowchart of the present invention;

FIG. 5 displays the tree trunk stress analysis and fracture prediction flowchart of the present invention.

### DETAILED DESCRIPTIONS OF THE EMBODIMENTS

The technical solutions of the embodiments of the present invention shall now be described clearly and completely with reference to the accompanying drawings. It is evident that the described embodiments represent a portion of the embodiments of the present invention, not the entirety thereof. All other embodiments obtained by persons skilled in the art based on the embodiments herein, without involving creative labor, shall fall within the scope of protection of the present invention.

### Example 1

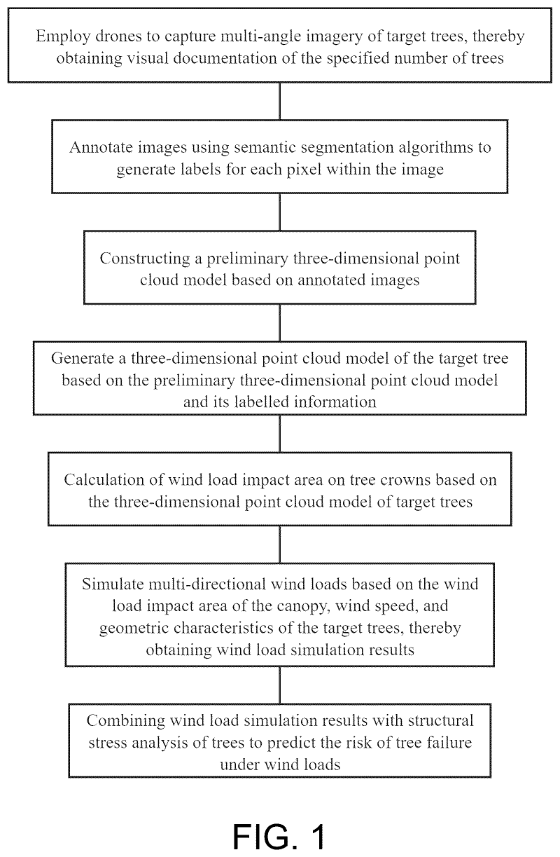

This embodiment provides a tree wind load assessment method based on point cloud modelling. Through techniques including unmanned aerial vehicle (UAV) image acquisition, image semantic segmentation, three-dimensional point cloud reconstruction, wind load simulation, and structural stress analysis, it enables efficient and accurate evaluation of the risk of tree damage under wind forces. As illustrated in FIG. 1, the method comprises the following steps:
Employ unmanned aerial vehicles to capture multi-angle imagery of target trees, thereby acquiring visual representations of the subject trees;
Annotate images using semantic segmentation algorithms to generate labels for each pixel within the image;
Construct a preliminary three-dimensional point cloud model based on annotated images;
Generate a three-dimensional point cloud model of the target tree based on the preliminary three-dimensional point cloud model and its label information;
Calculate the wind load impact area of the tree crown based on the aforementioned three-dimensional point cloud model of the target tree;
Simulate multi-directional wind loads based on the wind load-affected area of the canopy, wind speed, and geometric characteristics of the target trees, thereby obtaining wind load simulation results;
Combining wind load simulation results with structural stress analysis of trees, the risk of tree failure under wind loads is predicted.

Specifically, this includes the following:

By capturing multi-angle imagery of target trees via unmanned aerial vehicles (UAVs), image data pertaining to the trees is obtained. The imagery collected by UAVs possesses high resolution and precision, enabling comprehensive and detailed acquisition of the trees' morphological information. The advantage of this procedure lies in the efficient imaging capability of UAVs, which allows for the rapid acquisition of substantial quantities of high-quality imagery. This approach circumvents the inefficiencies and high costs associated with traditional manual surveying methods.

Following image acquisition, semantic segmentation algorithms are employed to annotate the imagery. Each pixel within the image is assigned label information, encompassing tree crowns, trunks, and background elements. This process utilizes pre-trained convolutional neural networks (such as Mask R-CNN), enabling precise identification of distinct tree components. This technology effectively separates tree crowns, trunks, and backgrounds, eliminating data from irrelevant areas to ensure more precise extraction of tree components during subsequent processing. The advantage of this technical feature lies in its efficient image processing and high-precision regional annotation, reducing manual intervention while enhancing processing speed and accuracy.

Subsequently, a preliminary three-dimensional point cloud model is constructed based on the annotated images. Utilizing COLMAP three-dimensional reconstruction software, multi-view three-dimensional reconstruction is performed on the captured images to generate a non-semantic point cloud model. This process employs the SIFT algorithm to extract image feature points and applies the RANSAC algorithm to eliminate misaligned points, ultimately achieving the fusion of multi-view point cloud data. This step yields a relatively precise three-dimensional point cloud model of the trees, providing foundational data for subsequent wind load analysis. The advantage of this technical approach lies in its utilization of geometric relationships between images. Through automated algorithmic processing, it significantly enhances the efficiency and accuracy of model construction while avoiding the tediousness and errors associated with manual modelling.

Information regarding the various components of trees is extracted from the preliminary three-dimensional point cloud model to generate a three-dimensional point cloud model of the target tree. During this process, debris unrelated to the tree is removed based on geometric conditions involving color, position, and normal vectors, whilst point cloud data labelled as crown and trunk is extracted. The point cloud is further simplified using a voxel meshing algorithm to reduce redundant points, and noise is eliminated through the SOR filtering algorithm. The resulting target tree 3D point cloud model accurately reflects the tree's geometric shape, providing a reliable data source for calculating the area affected by wind loads. The advantage of this technical feature lies in ensuring the accuracy and validity of the point cloud data through debris removal, data simplification, and noise reduction, thereby minimizing potential errors in subsequent analyses.

Based on the three-dimensional point cloud model of the target tree, the wind load impact area of the canopy is calculated. First, point cloud data labelled as the canopy is extracted from the target tree's three-dimensional point cloud model to generate a three-dimensional point cloud model of the canopy. Subsequently, the three-dimensional point cloud model of the tree canopy is projected along a predetermined direction to obtain two-dimensional planar data of the canopy. Next, the three-dimensional coordinates of the tree canopy point cloud data are converted into two-dimensional coordinates, yielding a two-dimensional point set of the canopy. The Alpha Shape algorithm is employed to compute the boundary envelope of the two-dimensional point set of the tree canopy, thereby determining the wind load impact area of the canopy. The specific calculation formula is as follows:

$$A = {\sum }_{i = 1}^{n} \frac{1}{2} \vert {x}_{i} {y}_{i + 1} - {x}_{i + 1} {y}_{i} \vert$$

Where A denotes the wind load-affected area of the tree crown, (xᵢ, yᵢ) represents the two-dimensional coordinates of the i-th point cloud data within the tree crown's two-dimensional point set, n signifies the total number of point cloud data points in the tree crown's two-dimensional point set, and (xₙ₊₁, yₙ₊₁) is regarded as forming a closed path with (x₁, y₁).

Through calculations utilizing two-dimensional projection and the Alpha Shape algorithm, the effective wind load impact area of the tree canopy can be accurately determined, thereby providing an accurate foundation for wind load simulation.

During the wind load simulation phase, the wind resistance coefficients for the tree crown and trunk are calculated based on the target tree's geometric characteristics. The three-dimensional point cloud model of the crown is converted into a three-dimensional CAD model and imported into ANSYS Fluent software. Fluent simulates the distribution of varying wind speeds and pressures generated from multiple directions, ultimately yielding the wind load simulation results. The wind load calculation formula is as follows:

$$F = \frac{1}{2} \cdot {C}_{d} \cdot A \cdot ρ \cdot {v}^{2}$$

Where F denotes wind load, C_{d} represents the drag coefficient, A signifies the wind load-affected area of the canopy, ρ denotes air density, and v indicates wind velocity. By precisely simulating wind loads acting upon trees under varying wind speeds and directions, reliable data is provided for structural stress analysis. Utilizing Fluent to simulate wind field flows enables consideration of multiple wind directions and differing wind speed conditions, delivering comprehensive and accurate results for wind load analysis on trees.

Combining wind load simulation results with structural stress analysis of trees. Based on the target tree's three-dimensional point cloud model, a finite element model of the tree is constructed. This model incorporates the tree's geometric shape, material properties, mechanical characteristics, and boundary conditions. Wind load simulation results are input into the finite element model as external loads acting upon individual nodes or elements, thereby calculating the structural stresses within the tree under wind loading. The structural stress calculation formula is:

$$σ = \frac{F}{{A}_{c r o s s}}$$

Where σ denotes stress, F denotes wind load, and A_{cross} denotes the cross-sectional area of the wind load application zone;
Based on the calculated structural stresses, combined with the fatigue strength and fatigue index of the target tree material, the fatigue life of the target tree under long-term wind loading is predicted using the following formula:

$${N}_{f} = {( \frac{Δσ}{{σ}_{f}} )}^{β}$$

Where N_{f} denotes fatigue life, Δσ denotes stress amplitude, obtained from the calculated structural stress, θ_{f} denotes the fatigue strength of the target tree material, and β denotes the fatigue index of the target tree material; This procedure enables the precise assessment of fatigue damage and failure risks in trees subjected to wind forces. Its technical merit lies in providing a scientific basis for evaluating tree health through structural stress and fatigue life calculations, thereby offering advance warning of potential damage risks from windstorms.

In summary, this implementation systematically assesses the risk of tree damage under wind loads through a combination of techniques including unmanned aerial vehicle (UAV) image acquisition, image semantic segmentation, three-dimensional point cloud reconstruction, wind load simulation, and finite element analysis. This method is characterized by its efficiency and precision, providing reliable technical support for wind disaster prevention and control, tree health monitoring, and related fields.

### Example 2

The aspects not mentioned herein are identical to those in example 1.

This embodiment provides a tree wind load assessment system based on tree point cloud models, comprising: a data acquisition and semantic segmentation module; a point cloud model generation and processing module; a wind load simulation calculation module; and a tree trunk stress analysis and fracture prediction module. These modules operate in concert to deliver a comprehensive solution spanning from data collection to final wind disaster prediction.

Data Acquisition and Semantic Extraction Module, comprising a Data Acquisition Submodule and an Image Semantic Segmentation Submodule. This module acquires images via unmanned aerial vehicles and employs neural networks for semantic segmentation of the imagery. It outputs semantic segmentation maps for each image, wherein each pixel is assigned a label. Labels include canopy, trunk, and background.

The data acquisition submodule employs unmanned aerial vehicles (UAVs) equipped with high-resolution cameras to capture multi-angle imagery of target trees. This ensures comprehensive coverage of the entire tree area with the highest possible image quality. Flight paths are meticulously planned to guarantee optimal image overlap and coverage, thereby facilitating subsequent three-dimensional reconstruction.

The image semantic segmentation submodule employs open-source neural network models to automatically identify tree canopy areas through semantic segmentation of drone-captured imagery. This process efficiently distinguishes tree canopies from trunks, environmental debris, and other non-target regions, thereby mitigating noise interference within the data. The model is capable of handling complex backgrounds and varying lighting conditions.

Point cloud model generation and processing module, comprising a point cloud model generation sub-module and a noise reduction processing sub-module. Preliminary data obtained through the UAV image acquisition and semantic extraction module undergoes further processing to generate a complete point cloud model.

The point cloud model generation submodule employs open-source 3D reconstruction software such as COLMAP to perform multi-view 3D reconstruction on captured images, generating point cloud data. This process utilizes the SIFT algorithm to extract image feature points, combined with estimated camera positions and poses. Incremental 3D reconstruction is achieved through methods including nearest neighbor matching, relative pose constraints, and the five-point algorithm. The final output point cloud data constitutes a three-dimensional surface model of the tree, encompassing all point cloud data pertaining to the canopy, trunk, and surrounding environment.

The noise reduction submodule employs geometric conditions based on features such as color, position, and normal vectors to eliminate extraneous debris unrelated to trees, utilizing the aforementioned semantic segmentation results and geometric characteristics of point cloud data. The point cloud data is simplified using a voxel grid algorithm. By spatially partitioning the point cloud into a grid, redundant points are reduced, thereby decreasing computational load. Furthermore, the SOR filtering algorithm is employed to eliminate noise within the point cloud data. This removes noise caused by factors such as variations in illumination and weather conditions, yielding point cloud data of the canopy region that is both densely uniform and highly accurate.

The wind load simulation calculation module comprises a wind-affected area calculation submodule and a wind load simulation calculation submodule. Based on the point cloud model processed previously, this module calculates the wind load effects on trees by integrating parameters such as wind speed and tree structure. Through physical modelling and computational fluid dynamics simulation, it computes wind loads acting upon trees under varying wind speeds and directions, thereby assessing the structural stability of the trees:

The area calculation submodule projects the tree crown point cloud data along a specified direction. This projection process converts the three-dimensional point cloud into two-dimensional planar data, forming a point set. This point set represents the cross-sectional morphology of the tree crown in that direction. The projection direction undergoes dynamic adjustment based on variations in wind speed and direction. To address the irregular geometry inherent in tree crowns, this module employs the Alpha Shape algorithm to compute the envelope of the point set. By applying Alpha Shape processing to the tree crown point cloud data, the module precisely captures the crown's shape and calculates its wind load impact area.

The wind load simulation calculation submodule assesses surface complexity or roughness by analyzing point cloud density, thereby calculating wind resistance coefficients for trees under varying projection configurations. Dense areas (such as foliage) yield higher wind resistance coefficients, whereas sparse regions (such as bare branches) yield lower coefficients.

The extracted canopy point cloud data is converted into a three-dimensional CAD model and imported into Fluent. The wind resistance coefficient function is input into ANSYS Fluent software, which simulates the distribution of wind speeds and pressures generated by winds from multiple directions. Analysis of the resulting flow field simulations yields pressure distributions and wind load outcomes for each region, enabling further calculation of structural stresses and fracture risks for individual tree components.

Due to factors such as the morphology and arrangement of tree crowns and foliage affecting airflow, trees create obstacles to air currents when analyzed collectively, altering flow velocities and pressure distributions. These localized wind flow variations influence wind load calculations. This module employs Fluent to simulate wind tunnel effects, providing visualization tools to display streamlines, velocity vector plots, and wind pressure distribution maps. These tools offer an intuitive representation of wind direction and velocity, thereby revealing potential localized wind acceleration or deceleration within the forest canopy. This facilitates the identification of areas susceptible to significant impact.

The Tree Trunk Stress Analysis and Fracture Prediction Module utilizes wind pressure results obtained from the aforementioned CFD simulations. Integrated with ANSYS Mechanical structural analysis software, it enables deformation and displacement analysis of trees under wind loads, alongside dynamic response analysis under wind loading. This facilitates the assessment of fracture risk when trees encounter high winds.

Input the point cloud model and material properties of the trees into the software, alongside wind load data obtained from CFD simulations, to conduct structural stress analysis.

Through fluid-structure interaction (FSI) analysis, the deformation and structural response of trees under wind loads are simulated. This methodology accounts not only for the static effects of wind loads but also simulates the transient responses of trees under dynamic wind action, such as tree vibration and sway.

Fatigue fracture analysis: Trees experience periodic wind loads during exposure to wind, leading to fatigue damage. ANSYS Mechanical can perform fatigue analysis to assess a tree's fatigue life under prolonged wind loading and identify regions susceptible to fatigue damage. At vulnerable points such as branch-trunk junctions, wind loads readily induce fracture or failure. Simulating wind-induced fracture through fracture mechanics analysis aids in determining a tree's risk of breaking during high winds.

Instability and collapse analysis: For taller trees, the risk of instability and collapse during high winds can be assessed through wind load simulation results.

### Example 3

This embodiment shares identical components with example 1 where not otherwise specified.

This embodiment pertains to a tree wind load assessment system based on tree point cloud models, comprising the following principal components:

Data Acquisition and Semantic Analysis Module, including a Data Acquisition Submodule and an Image Semantic Segmentation Submodule.

Point Cloud Model Generation and Processing Module, comprising a Point Cloud Model Generation Submodule and a Noise Reduction Processing Submodule.

The wind load simulation calculation module comprises a sub-module for calculating affected areas and a sub-module for wind load simulation calculations.

The tree trunk stress analysis and fracture prediction module incorporates submodules for fluid-structure interaction and fatigue and buckling analysis.

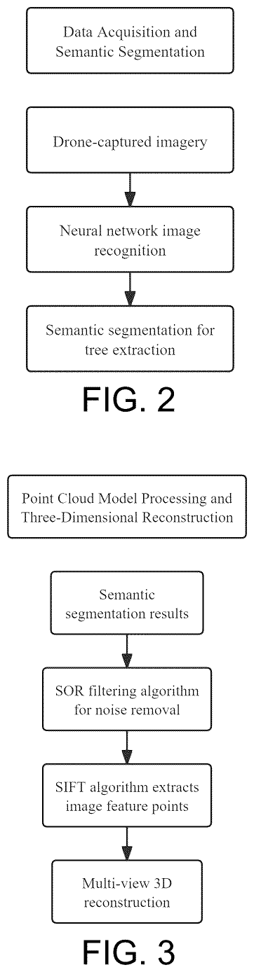

The data acquisition and semantic segmentation process, as illustrated in FIG. 2, comprises the following steps:
A drone flies along a predetermined trajectory to capture imagery. The flight path must account for overlapping pixels across all orientations and encompass every angle of the trees to facilitate subsequent three-dimensional reconstruction;
Preprocess the images captured by the drone, removing those obscured by obstructions or poor illumination, then import the images into the neural network;
The neural network performs semantic segmentation on the processed images, accurately distinguishing trees from the background and extracting the canopy regions. These serve as the source images for subsequent point cloud model generation.

The process of generating the point cloud model is illustrated in FIG. 3 and comprises the following steps:
Import the semantic segmentation results into the 3D reconstruction software, which converts the images into 3D point cloud data;
Simplify the point cloud data using voxel meshing and SOR filtering algorithms to remove redundancy and noise, ensuring clarity and accuracy;
The software employs the SIFT algorithm to extract key feature points, utilizing these to perform three-dimensional reconstruction and generate a three-dimensional surface model of the trees. Geometric conditions based on features such as color, position, and normal vectors are applied to remove debris unrelated to the trees, ensuring the point cloud model possesses a high degree of three-dimensional fidelity. This enables precise representation of the trees' three-dimensional information for subsequent wind load calculations.

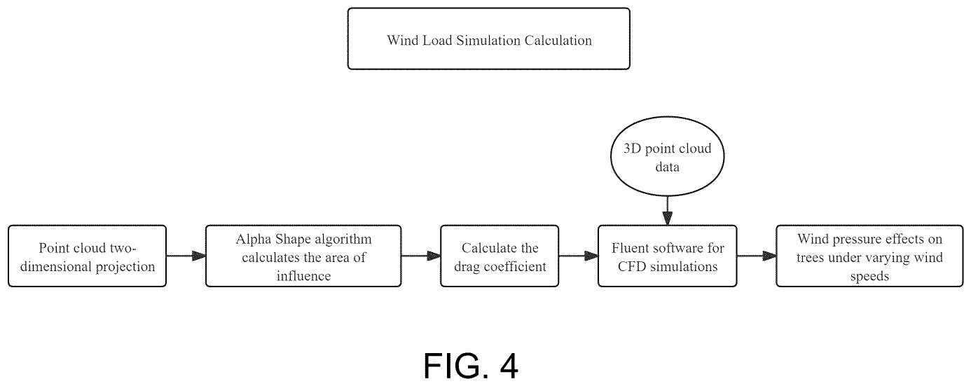

The process of wind load simulation calculation is illustrated in FIG. 4, comprising the following steps:

Project the tree crown point cloud data along a specified direction. The two-dimensional planar projection yields a point set representing the cross-sectional morphology of the tree crown in that direction. Employ the Alpha Shape algorithm to select an appropriate radius parameter and calculate the area of this irregular image, which constitutes the wind load impact area in that direction;

Assess surface complexity or roughness by analyzing point cloud density. Calculate wind resistance coefficients for different projected tree forms to facilitate CFD simulation.

Import three-dimensional point cloud data and wind resistance coefficient function information into ANSYS Fluent for multi-directional wind speed and wind pressure distribution simulation. The software can simulate wind tunnel-like effects and provides visualization tools to help identify areas susceptible to wind loads. CFD simulations yield data such as pressure fields and wind load distributions, whilst also displaying the streamlines and vortex structures formed by fluid flow around trees.

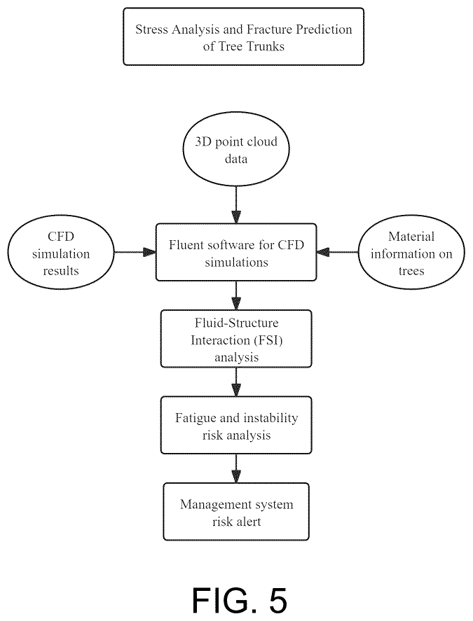

The process for trunk stress analysis and fracture prediction, as illustrated in FIG. 5, comprises the following steps:

Import the wind pressure data obtained from the wind load simulation, alongside the point cloud model and tree material properties, into ANSYS Mechanical structural analysis software for evaluation;

Through fluid-structure interaction (FSI) analysis, the deformation and structural changes of trees under wind loads can be simulated to analyze their displacement and vibration responses under varying wind forces.

Integrating FSI results, fatigue fracture risk assessments are conducted on vulnerable tree components (such as branch-trunk junctions), while taller trees undergo evaluation for instability and collapse risks during high winds. These risk assessment outcomes can be integrated into upper-level management systems to enable enhanced risk warning capabilities.

The aforementioned functions, when implemented as software functional units and sold or used as independent products, may be stored on a computer-readable storage medium. Based on this understanding, the technical solution of the present invention, in essence or in the portion constituting a contribution to the prior art, or a portion thereof, may be embodied as a software product. This computer software product is stored on a storage medium and comprises a plurality of instructions for causing a computer device (which may be a personal computer, server, or network device, etc.) to execute all or part of the steps of the methods described in the various embodiments of the present invention. The aforementioned storage media include: USB flash drives, portable hard drives, read-only memory (ROM), random access memory (RAM), magnetic disks, optical discs, and other media capable of storing program code.

The foregoing description constitutes merely specific embodiments of the present invention; however, the scope of protection of the invention is not limited thereto. Any person skilled in the art may readily conceive of various equivalent modifications or substitutions within the technical scope disclosed herein, and such modifications or substitutions shall be encompassed within the scope of protection of the invention. Therefore, the scope of protection of the invention shall be determined by the scope of the claims.

What is claimed is:

1. A method for assessing wind loads on trees based on point cloud models, comprising the following steps:
employing unmanned aerial vehicles to capture multi-angle imagery of target tree, thereby acquiring visual representations of the subject trees;
applying image semantic segmentation algorithms to annotate the imagery, generating labels for each pixel within the images, these labels comprise tree crowns, tree trunks, and background elements;
constructing a preliminary three-dimensional point cloud model based on the annotated imagery, each point cloud data point within this preliminary model incorporates corresponding label information,
generating a three-dimensional point cloud model of the target tree based on the preliminary three-dimensional point cloud model and its label information;
calculating the wind load impact area of the tree crowns based on the aforementioned three-dimensional point cloud model of the target tree;
simulating multi-directional wind loads based on the wind load impact area of the canopy, wind speed, and the target tree's geometric characteristics to obtain wind load simulation results, wherein the target tree's geometric characteristics are derived from the target tree's 3D point cloud model;
conducting structural stress analysis on the tree in conjunction with the wind load simulation results to predict the risk of tree failure under wind forces,
the calculation of wind load impact area on tree crowns based on the target tree's three-dimensional point cloud model comprises the following steps:
extracting point cloud data labelled as the tree crowns from the target tree's three-dimensional point cloud model to generate a three-dimensional point cloud model of the tree crowns;
projecting the canopy point cloud data from the three-dimensional canopy point cloud model along a predetermined direction, converting the three-dimensional canopy point cloud model into two-dimensional planar data;
converting the three-dimensional coordinates within the three-dimensional canopy point cloud model into corresponding two-dimensional coordinates according to the predetermined direction, thereby obtaining a two-dimensional point set for the canopy,
employing the Alpha Shape algorithm to compute the boundary envelope of the two-dimensional point set representing tree crown yields the wind load impact area of the crown;
based on the wind load impact area of the crown, wind speed, and geometric characteristics of the target tree, simulate multi-directional wind loads to obtain wind load simulation results, comprising the following steps:
calculating wind resistance coefficients at the tree crowns and the tree trunk based on the target tree's geometric characteristics; generating a three-dimensional CAD model from the tree crown's point cloud data and import it into Fluent; inputting the wind resistance coefficients at the tree crowns and tree trunks into ANSYS Fluent software; using Fluent to simulate wind velocity and pressure distributions generated by winds from multiple directions; analyzing the resulting flow field simulation outcomes to obtain wind load simulation results, calculated using the formula:
$$F = \frac{1}{2} \cdot {C}_{d} \cdot A \cdot ρ \cdot {v}^{2}$$
where F denotes wind load, C_{d} represents the drag coefficient, A signifies the wind load-affected area of the canopy, ρ denotes air density, and v indicates wind velocity.

2. The method for assessing wind loads on the trees based on the point cloud models according to claim 1, wherein the image annotation performed via an image semantic segmentation algorithm generates labels for each pixel within the image, comprising the following steps:
performing preprocessing operations on captured images, including denoising and color correction;
inputting the preprocessed images into a pre-trained convolutional neural network model for semantic segmentation, outputting semantic segmentation maps for each image, each pixel within the semantic segmentation map is assigned a label, the convolutional neural network model includes the Mask R-CNN model.

3. The method for assessing wind loads on the trees based on the point cloud models according to claim 1, wherein the construction of a preliminary three-dimensional point cloud model based on annotated images comprises the following steps:
performing multi-view three-dimensional reconstruction of captured images using COLMAP three-dimensional reconstruction software to generate a non-semantic three-dimensional point cloud model;
computing the three-dimensional coordinates of each pixel within the semantic segmentation map of each image in the non-semantic 3D point cloud model, determining the corresponding point cloud data for each pixel based on its three-dimensional coordinates, passing the labels of each pixel to the corresponding point cloud data to generate a preliminary 3D point cloud model.

4. The method for assessing wind loads on the trees based on the point cloud models according to claim 3, wherein the employing COLMAP three-dimensional reconstruction software to perform multi-view three-dimensional reconstruction on captured images, generating a non-semantic three-dimensional point cloud model, comprising the following steps:
the SIFT algorithm is employed to extract feature points and their descriptors from each image, a nearest neighbor matching algorithm is then applied to match feature points across multiple images based on their respective descriptors, the RANSAC algorithm is utilized to eliminate erroneously matched feature points,
based on the matched feature points, COLMAP is employed to construct a non-semantic 3D point cloud model through an incremental reconstruction method.

5. The method for assessing wind loads on the trees based on the point cloud models according to claim 1, wherein the generation of a target tree three-dimensional point cloud model from a preliminary three-dimensional point cloud model and its label information comprises the following steps:
by utilizing the semantic segmentation maps of each image and the geometric characteristics of point cloud data within a preliminary 3D point cloud model, non-tree debris is removed through geometric conditions based on color, position, and normal vectors;
point cloud data labelled as tree crowns and tree trunks is extracted from the preliminary 3D point cloud model;
simplifying the extracted point cloud data using a voxel grid algorithm, spatially partitioning the point cloud into a grid to reduce redundant points;
applying a SOR filtering algorithm to remove noise from the point cloud data, generating a three-dimensional point cloud model of the target tree.

6. The method for assessing wind loads on the trees based on the point cloud models according to claim 1, wherein the predetermined direction is dynamically adjusted according to variations in wind speed and wind direction.

7. The method for assessing wind loads on the trees based on the point cloud models according to claim 1, wherein the wind load impact area of the tree crowns is calculated using the following formula:
$$A = {\sum }_{i = 1}^{n} \frac{1}{2} \vert {x}_{i} {y}_{i + 1} - {x}_{i + 1} {y}_{i} \vert ,$$
where A denotes the wind load-affected area of the tree crowns, (xᵢ, yᵢ) represents the two-dimensional coordinates of the i-th point cloud data within the tree crown's two-dimensional point set, n signifies the total number of point cloud data points in the tree crown's two-dimensional point set, and (xₙ₊₁, yₙ₊₁) is regarded as forming a closed path with (x₁, y₁).

8. The method for assessing wind loads on the trees based on the point cloud models according to claim 1, wherein the combining wind load simulation results with structural stress analysis of the tree to predict the risk of failure under wind forces comprises the following steps:
based on the three-dimensional point cloud model of the target tree, a finite element model of the tree is constructed, the finite element model incorporates the tree's geometric shape, material properties, mechanical characteristics, and boundary conditions,
the results of the wind load simulation are input into the finite element model, acting as external loads applied to each node or element within the finite element model, and the structural stresses within the tree under wind load are calculated using the following formula:
$$σ = \frac{F}{{A}_{c r o s s}} ,$$
where σ denotes stress, F denotes wind load, and A_{cross} denotes the cross-sectional area of the wind load application zone;
based on the calculated structural stresses, combined with the fatigue strength and fatigue index of the target tree material, the fatigue life of the target tree under long-term wind loading is predicted using the following formula:
$${N}_{f} = {( \frac{Δσ}{{σ}_{f}} )}^{β} ,$$
where N_{f} denotes fatigue life, Δσ denotes stress amplitude, obtained from the calculated structural stress, σ_{f} denotes the fatigue strength of the target tree material, and β denotes the fatigue index of the target tree material;
assess the risk of failure of target tree under wind loads based on their predicted fatigue life under long-term wind loading.

9. The method for assessing wind loads on the trees based on the point cloud models according to claim 2, wherein the construction of a preliminary three-dimensional point cloud model based on annotated images comprises the following steps:
performing multi-view three-dimensional reconstruction of captured images using COLMAP three-dimensional reconstruction software to generate a non-semantic three-dimensional point cloud model;
computing the three-dimensional coordinates of each pixel within the semantic segmentation map of each image in the non-semantic 3D point cloud model, determining the corresponding point cloud data for each pixel based on its three-dimensional coordinates, and passing the labels of each pixel to the corresponding point cloud data to generate a preliminary 3D point cloud model.

10. The method for assessing wind loads on the trees based on the point cloud models according to claim 2, wherein the generation of a target tree three-dimensional point cloud model from a preliminary three-dimensional point cloud model and its label information comprises the following steps:
by utilizing the semantic segmentation maps of each image and the geometric characteristics of point cloud data within a preliminary 3D point cloud model, non-tree debris is removed through geometric conditions based on color, position, and normal vectors;
point cloud data labelled as tree crowns and tree trunks is extracted from the preliminary 3D point cloud model;
simplifying the extracted point cloud data using a voxel grid algorithm, spatially partitioning the point cloud into a grid to reduce redundant points; and
applying a SOR filtering algorithm to remove noise from the point cloud data, generating a three-dimensional point cloud model of the target tree.
